(19) United States
(12) Patent Application Publication
(10) Pub. No.: US 2026/0352069 A1
(43) Pub. Date: Nov. 5, 2026

(54) Motor

(71) Applicant: AAC Acoustic Technologies (Shanghai) Co., Ltd., Shanghai (CN)

(72) Inventors: Kaiqi Xu, Shanghai (CN); Leping Dong, Shanghai (CN); Liang Jiang, Shanghai (CN)

(21) Appl. No.: 19/305,748

(22) Filed: Aug. 20, 2025

Related U.S. Application Data
(63) Continuation of application No. PCT/CN2025/092412, filed on Apr. 30, 2025.

(51) Int. Cl. H02K 11/21; H02K 1/28; H02K 5/16

(52) U.S. Cl. CPC H02K 11/21; H02K 1/28; H02K 5/161

(57) ABSTRACT

The present invention provides a motor including a housing, a motor shaft, and a rotor. The motor shaft includes a first end portion and a second end portion. The housing includes a main portion and a cover. The motor shaft has a hollow structure. The motor shaft has an accommodation cavity. The motor further includes a magnetic ring at least partially accommodated in the accommodation cavity and a signal acquisition device installed and fixed on the cover and disposed opposite to the magnetic ring. The rotor rotates and drives the motor shaft and the magnetic ring to rotate. The signal acquisition device determines a motion position of the rotor by recognizing a magnetic field position signal provided by the magnetic ring. The motor of the present invention has a more compact structure, and the present invention effectively shortens an axial length of the motor.

The present invention relates to the field of motor, and more particularly, to a brushless motor.

### DESCRIPTION OF RELATED ART

Currently, with the rapid development of the artificial intelligence and robotics industries, the requirements for motors have become stricter due to factors such as space and energy efficiency. Motors are developing towards higher integration, smaller size, higher load capacity, and faster response. In related art, the brushless motors, when current passes through the stator coil, a rotating magnetic field is formed. The permanent magnet in the rotor is subjected to the effect of this rotating magnetic field, generating a rotational torque in the direction of the magnetic field, which in turn drives the rotor to rotate, thus achieving the operation of the motor.

However, in related art, the motor has a rotary encoder magnetic ring used to provide magnetic field position signals, enabling the rotary encoder to recognize the relative position between the stator and rotor of the motor, thereby achieving electronic phase exchange of the motor. The rotary encoder magnetic ring used to provide the position of the motor rotor is directly fixed on the outside of the motor’s central shaft, which increasing the axial length of the motor.

Therefore, it is desired to provide a new motor which can overcome the above problems.

### SUMMARY

In view of the above, the embodiments of the present invention provide a new motor with a compact structure and a trend towards miniaturization.

The present invention provides a motor including a housing, a motor shaft received in the housing and partially extending out of the housing, a stator fixedly connected to the housing, and a rotor fixedly connected to the motor shaft. The motor shaft includes a first end portion located in the housing and a second end portion extending out of the housing. The housing includes a main portion and a cover covered on the main portion. The cover covers on a side of the main portion close to the first end portion. The motor shaft has a hollow structure. The motor shaft has an accommodation cavity. The motor further includes a magnetic ring at least partially accommodated in the accommodation cavity and a signal acquisition device installed and fixed on the cover and disposed opposite to the magnetic ring. The rotor rotates and drives the motor shaft and the magnetic ring to rotate. The signal acquisition device determines a motion position of the rotor by recognizing a magnetic field position signal provided by the magnetic ring.

As an improvement, the motor further includes a magnet mounting base accommodated in the accommodation cavity, and the magnetic ring is mounted and fixed on the magnet mounting base.

As an improvement, at least half of the magnetic ring is accommodated in the accommodation cavity of the motor shaft in an extension direction of the motor shaft.

As an improvement, the motor shaft is made of magnetic conductive material.

As an improvement, the rotor includes a permanent magnet sleeved on the motor shaft, and the permanent magnet is a 4-pole magnetizing structure or more pole magnetizing structure along a diameter direction.

As an improvement, the stator includes a stator iron core fixed on an inner surface of the housing and a stator coil located between the stator iron core and the permanent magnet, the stator coil attached on an inner surface of the stator iron core.

As an improvement, the stator iron core is a magnetic conductive structure and has an annular shape, the stator iron core composed of a plurality of silicon steel sheets stacked together, the plurality of silicon steel sheets and fixed by bonding to form the stator iron core, or, the plurality of silicon steel sheets fixed by riveting to form the stator iron core.

As an improvement, the magnetic ring is a 2-pole magnetizing structure or more pole magnetizing structure along a diameter direction.

As an improvement, the motor further includes a first bearing member fixed between the housing and the motor shaft, the first bearing member being located close to the second end portion of the motor shaft, the first bearing member being a rolling bearing member, the first bearing member including a first surface connected to the housing and a second surface connected to the motor shaft, the motor shaft bringing the second surface of the first bearing member to rotate.

As an improvement, the motor further includes a second bearing member fixed between the housing and the first end portion of the motor shaft, and the motor shaft rotates relative to the second bearing member.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a motor in accordance with the present invention.

FIG. 2 is a partially exploded view of the motor of FIG. 1.

FIG. 3 is an exploded view of the motor of FIG. 1.

FIG. 4 is an illustrative cross-sectional view of the motor taken along line A-A of FIG. 1.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

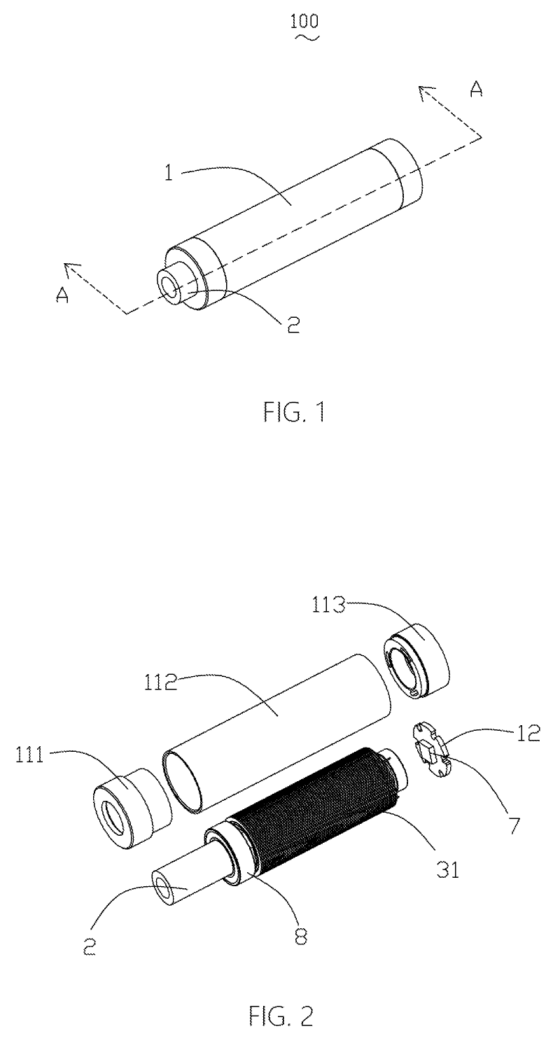

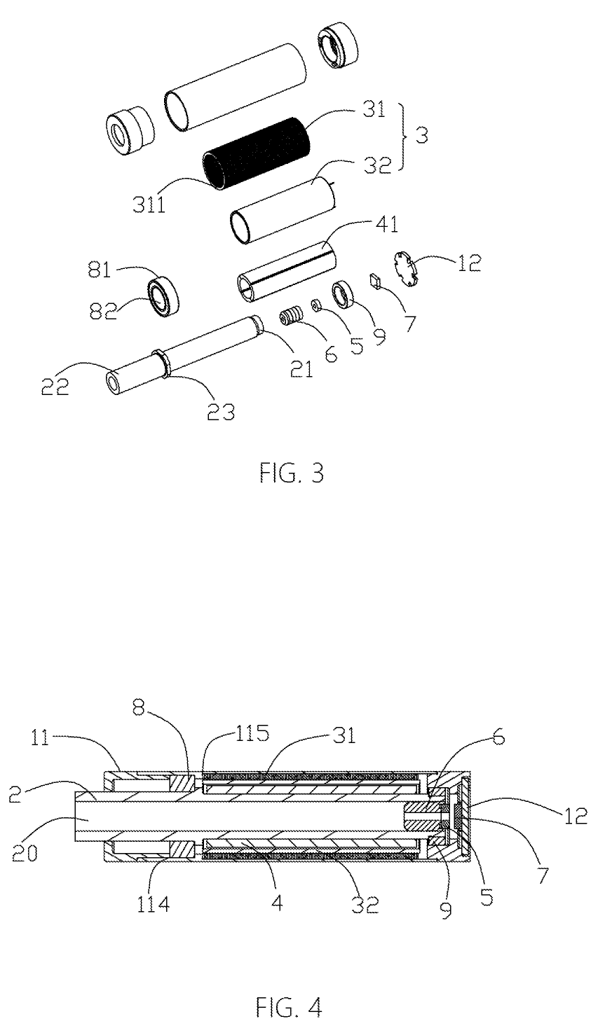

Referring to the FIGS. 1-4, the present invention provides a motor 100, and the motor 100 can be applied to dexterous fingers or joints of robots. The motor 100 includes a housing 1, a motor shaft 2 received in the housing 1 and partially extending out of the housing 1, a stator 3 fixedly connected to the housing 1, a rotor 4 fixedly connected to the motor shaft 2, a magnetic ring 5 connected to the motor shaft 2 for providing a magnetic field position signal, a magnet mounting base 6 used for fixing magnetic ring 5, a signal acquisition device 7 for detecting the magnetic field position signal, a first bearing member 8 mounted in one end of the housing 1, and a second bearing member 9 mounted in the other end of the housing 1.

The housing 1 includes a main portion 11 and a cover 12 covered on an end of the main portion 11. The main body 11 has a barrel shape structure. The main body 11 is a three-segment structure. The main body 11 includes a first main body part 111, a second main body part 112, and a third main body part 113 connected in sequence. The first main body part 111, the second main body part 112, and the third main body part 113 are connected by welding or glue. The first main body part 111 at least partially overlaps with the second main body part 112, and the first main body part 111 and the second main body part 112 cooperate to form a first receiving portion 114 for accommodating part of the first bearing member 8. The stator 3 is mounted in the second main body part 112. The second main body part 112 is provided with a second receiving portion 115 for receiving part of the stator 3, and the third main body part 113 is fixedly connected to the cover 12.

The motor shaft 2 has a hollow structure. The motor shaft 2 has an accommodation cavity 20. The motor shaft 2 is made of magnetic conductive material. The motor shaft 2 includes a first end portion 21 located in the housing 1 and close to the cover 12, and a second end portion 22 extending out of the housing 1. The cover 12 covers on a side of the main portion 11 close to the first end portion 21. The motor shaft 2 includes an abutting protrusion 23, and the first bearing member 8 is arranged against the abutting protrusion 23. The second bearing member 9 is mounted on the first end portion 21 and is sandwiched between the first end portion 21 and the third main body part 113.

The stator 3 includes a stator iron core 31 fixed on an inner surface of the housing 1 and a stator coil 32 attached on an inner surface of the stator iron core 31. The stator iron core 31 is a magnetic conductive structure and has an annular shape, and the stator iron core 31 is composed of a plurality of silicon steel sheets 311 stacked together. The plurality of silicon steel sheets 311 are fixed by bonding to form the stator iron core 31, or, the plurality of silicon steel sheets 311 are fixed by riveting to form the stator iron core 31. The stator 3 is of a structure having no slot, and the motor 100 has small shake during speed regulation, which makes structure and performance of the motor more stable.

The rotor 4 includes a permanent magnet 41 sleeved on the motor shaft 2. The permanent magnet 41 is a 4-pole magnetizing structure or more pole magnetizing structure along a diameter direction. For example, the permanent magnet 41 can be a 6-pole permanent magnet. The permanent magnet 41 is arranged with an annular structure and is attached on an outer side of the motor shaft 2. Alternatively, the material of the permanent magnet 41 is sintered neodymium iron boron. The stator coil 32 locates between the stator iron core 31 and the permanent magnet 41. The rotor 4 of the motor 100 is of a permanent magnet structure, which make the motor has a simple structure. The motor 100 has no brush friction, ensuring a rapid dynamic response.

The magnetic ring 5 locates on the first end portion 21 of the motor shaft 2 and is at least partially accommodated in the accommodation cavity 20. Alternatively, at least half of the magnetic ring 5 is accommodated in the accommodation cavity 20 of the motor shaft 2 in an extension direction of the motor shaft 2. Of course, the magnetic ring 5 can also be completely received in the accommodation cavity 20. In this case, an axial length of the motor 100 can be minimized to the greatest extent. The magnetic ring 5 is a 2-pole magnetizing structure or more pole magnetizing structure along the diameter direction. For example, the magnetic ring 5 can be a 4-pole magnetizing structure.

The magnetic ring 5 can be directly fixed to the accommodation cavity 20 of the motor shaft 2 by gluing, or alternatively, the magnetic ring 5 can be fixed to the motor shaft 2 through the magnet mounting base 6. The magnetic ring 5 is mounted and fixed on the magnet mounting base 6. The magnet mounting base 6 is completely accommodated in the accommodation cavity 20, that is, an end surface of the magnet mounting base 6 does not extend beyond the end surface of the motor shaft 2.

The signal acquisition device 7 is installed and fixed on the cover 12 and disposed opposite to the magnetic ring 5. That is, the signal acquisition device 7 is arranged aligned with the magnetic ring 5. The rotor 4 rotates and drives the motor shaft 2, the magnet mounting base 6 and the magnetic ring 5 to rotate. The signal acquisition device 7 determines a motion position of the rotor 4 by recognizing a magnetic field position signal provided by the magnetic ring 5, thereby achieving electronic phase exchange of the motor 100.

The first bearing member 8 is fixed between the housing 1 and the motor shaft 2. The first bearing member 8 is located close to the second end portion 22 of the motor shaft 2. The first bearing member 8 is a rolling bearing member. The first bearing member 8 includes a first surface 81 connected to the housing 1 and a second surface 82 connected to the motor shaft 2. The motor shaft 2 brings the second surface 82 of the first bearing member 8 to rotate. The first surface 81 is stationary relative to the housing 1. Specifically, a plurality of balls can be arranged between the first surface 81 and the second surface 82 to achieve partial rotation of the first bearing member 8.

The second bearing member 9 is fixed between the housing 1 and the first end portion 21 of the motor shaft 2, and the motor shaft 2 rotates relative to the second bearing member 9. That is, the second bearing member 9 is stationary relative to the housing 1.

Comparing with the related art, the present invention provides a motor including a housing, a motor shaft received in the housing and partially extending out of the housing, a stator fixedly connected to the housing, and a rotor fixedly connected to the motor shaft. The motor shaft includes a first end portion located in the housing and a second end portion extending out of the housing. The housing includes a main portion and a cover covered on the main portion. The cover covers on a side of the main portion close to the first end portion. The motor shaft has a hollow structure. The motor shaft has an accommodation cavity. The motor further includes a magnetic ring at least partially accommodated in the accommodation cavity and a signal acquisition device installed and fixed on the cover and disposed opposite to the magnetic ring. The rotor rotates and drives the motor shaft and the magnetic ring to rotate. The signal acquisition device determines a motion position of the rotor by recognizing a magnetic field position signal provided by the magnetic ring. The motor of the present invention forms the accommodation cavity by setting the motor shaft of the motor to a hollow structure. The magnetic ring used to provide the magnetic field position signal is at least partially received in the accommodation cavity, which effectively reducing the axial length of the motor, making the structure of the motor more compact and tending towards miniaturization.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A motor, comprising:
a housing, the housing comprising a main portion and a cover covered on the main portion;
a motor shaft received in the housing and partially extending out of the housing, the motor shaft comprising a first end portion located in the housing and a second end portion extending out of the housing, the cover covered on a side of the main portion close to the first end portion of the motor shaft, the motor shaft having a hollow structure, the motor shaft comprising an accommodation cavity;
a stator fixedly connected to the housing;
a rotor fixedly connected to the motor shaft;
a magnetic ring at least partially accommodated in the accommodation cavity; and
a signal acquisition device installed and fixed on the cover and disposed opposite to the magnetic ring;
wherein the rotor rotates and drives the motor shaft and the magnetic ring to rotate, the signal acquisition device determining a motion position of the rotor by recognizing a magnetic field position signal provided by the magnetic ring.

2. The motor as described in claim 1, wherein the motor further comprises a magnet mounting base accommodated in the accommodation cavity, and the magnetic ring is mounted and fixed on the magnet mounting base.

3. The motor as described in claim 1, wherein at least half of the magnetic ring is accommodated in the accommodation cavity of the motor shaft in an extension direction of the motor shaft.

4. The motor as described in claim 1, wherein the motor shaft is made of magnetic conductive material.

5. The motor as described in claim 1, wherein the rotor comprises a permanent magnet sleeved on the motor shaft, and the permanent magnet is a 4-pole magnetizing structure or more pole magnetizing structure along a diameter direction.

6. The motor as described in claim 5, wherein the stator comprises a stator iron core fixed on an inner surface of the housing and a stator coil located between the stator iron core and the permanent magnet, the stator coil attached on an inner surface of the stator iron core.

7. The motor as described in claim 6, wherein the stator iron core is a magnetic conductive structure and has an annular shape, the stator iron core composed of a plurality of silicon steel sheets stacked together, the plurality of silicon steel sheets fixed by bonding to form the stator iron core, or, the plurality of silicon steel sheets fixed by riveting to form the stator iron core.

8. The motor as described in claim 1, wherein the magnetic ring is a 2-pole magnetizing structure or more pole magnetizing structure along a diameter direction.

9. The motor as described in claim 1, wherein the motor further comprises a first bearing member fixed between the housing and the motor shaft, the first bearing member being located close to the second end portion of the motor shaft, the first bearing member being a rolling bearing member, the first bearing member comprising a first surface connected to the housing and a second surface connected to the motor shaft, the motor shaft bringing the second surface of the first bearing member to rotate.

10. The motor as described in claim 9, wherein the motor further comprises a second bearing member fixed between the housing and the first end portion of the motor shaft, and the motor shaft rotates relative to the second bearing member.
